(19) United States
(12) Patent Application Publication
(10) Pub. No.: US 2004/0256840 A1
(43) Pub. Date: Dec. 23, 2004

(54) Airbag module for motor vehicles

(75) Inventors: Gerhard Lutter, Bergfelde (DE); Thomas Marotzke, Bergefelde (DE)

Correspondence Address: FOLEY AND LARDNER, SUITE 500, 3000 K STREET NW, WASHINGTON, DC, 20007, US

(73) Assignee: TAKATA-PETRI AG

(21) Appl. No.: 10/895,965

(22) Filed: Jul. 22, 2004

Related U.S. Application Data
(63) Continuation of application No. PCT/DE03/00171, filed on Jan. 20, 2003.

(30) Foreign Application Priority Data
Jan. 25, 2002 (DE) 102 03 960.7

(51) Int. Cl. B60R 21/20; B60R 21/16

(52) U.S. Cl. 280/728.3

(57) ABSTRACT

An airbag module for motor vehicles including a airbag which can be inflated in order to protect a vehicle passenger. The envelope of the airbag includes a section facing the upper body of the vehicle passenger to be protected. The airbag module also includes a cover which frees an opening for the deployment of the airbag, during the inflation of the airbag, and an emblem region of the cover which is arranged in a fixed manner. The airbag includes an opening in the envelope through which the emblem region penetrates the inner chamber of the airbag during the deployment of the same. The opening is not oriented towards the upper body of the passenger to be protected when the airbag is inflated.

### CROSS-REFERENCE TO RELATED APPLICATIONS

This is a continuation of International Application PCT/DE03/00171, which has an international filing date of Jan. 20, 2003; this International Application was not published in English, but was published in German as WO 03/062023 A1. The foregoing international application is incorporated by reference herein in its entirety.

### BACKGROUND

The invention relates to an motor vehicle airbag module having a gas bag (i.e., airbag) which can be inflated to protect a vehicle occupant and the casing of which, in the inflated state of the gas bag, has a section facing the upper body of the vehicle occupant to be protected. An airbag module of this type comprises a gas bag which can be inflated by means of a gas generator to protect a vehicle occupant, a covering, behind which the gas bag is arranged in a folded state together with the gas generator and which, when the gas bag is inflated, opens up an opening for the deploying gas bag, and an emblem region which is arranged in a fixed position.

It is customary for airbag modules, in particular in “driver's airbag modules” which are arranged on the steering wheel of a motor vehicle, to have an emblem region which is provided with an emblem of the manufacturer of the corresponding vehicle. If the emblem region forms part of a flap of the airbag covering, which is coupled pivotably to the module housing and which, when the gas bag is inflated in the event of a crash, pivots to open up an opening for the deploying gas bag, then there is the problem that the risk of injury to a vehicle occupant is increased if he should collide with the flap, since use is frequently made of harder and heavier materials (e.g. metal) for the emblems than for the basic body of the flap itself, which consists of plastic. There is a risk of injury in particular in an “out of position” situation, in which a vehicle occupant is bent forward from his normal sitting position toward the airbag module. Moreover, there is the problem that, owing to the weight of the emblem, both the joining of the flap to the airbag module, which is undertaken as a rule via a film hinge, and the basic body of the flap, which consists of a comparatively soft material, may be exposed to excessive loads.

It is therefore known to arrange the emblem region in such a manner and to design the gas bag in such a manner that, when the gas bag is inflated, the emblem region is fixed in a fixed position and the inflatable regions of the gas bag are guided around the emblem. For this purpose, the gas bag may be designed, for example, as a ring-type airbag which, when inflated, surrounds the emblem, which is arranged centrally within the ring. However, there may be an increased risk of injury here to a vehicle occupant to be protected by the corresponding airbag module on account of the fact that the vehicle occupant (in particular in an out-of-position situation) plunges into the opening formed by the ring-type airbag and collides with the fixed emblem. Additional measures therefore have to be taken with which it can be ensured that, when the ring-type airbag is inflated, its opening is closed in such a manner that the penetration of a body part, in particular of the head, of the occupant to be protected into the opening is avoided.

### SUMMARY OF THE INVENTION

According to an embodiment of the present invention an airbag module is provided which endeavors to reduce the risk of injury to a vehicle occupant should he collide with the emblem region of an airbag module.

According to an embodiment of the present invention, an airbag module is provided. The module includes a gas bag which includes an opening through which the emblem region passes into the interior space of the gas bag during deployment, the opening being arranged in such a manner that, in the inflated state of the gas bag, it does not point in the direction of the upper body of the vehicle occupant to be protected.

As a result, in a crash situation, the emblem region is covered by the deploying gas bag and a collision of the emblem region with the upper body of a vehicle occupant (including his head) is thereby prevented. In an out-of-position situation, in particular, in which the vehicle occupant is bent forward toward the airbag module when the airbag module is triggered, the risk of injury is thus reduced.

At the same time, at least one flap of the airbag module, the pivoting of which enables the opening through which the gas bag is deployed from the airbag module to be opened up, can be of a reduced size compared with those cases in which the emblem region is part of this flap. As a result, an overloading of the joining of the flap during pivoting of the flap is avoided, and the risk of injury resulting from heavy components which move in a crash situation is reduced.

In the inflated state of the gas bag, the opening can either point in a direction laterally outward past the upper body of the occupant to be protected or can point in a direction away from the upper body of the occupant to be protected.

In the case of a gas bag which has an upper part and a lower part, the upper part facing the upper body of the occupant to be protected in the inflated state of the gas bag, the opening can be provided, for example, in the lower part of the gas bag, which part faces away from the upper body of the occupant to be protected. In this connection, the upper part and lower part of the gas bag can consist of two separate gas bag cutouts which are connected to each other (in particular sewn), or they are parts of an individual, single-piece gas bag cutout which defines an upper part and a lower part. On the other hand, the opening may also be provided in the region of a connecting seam of the upper part and lower part (upper fabric panel and lower fabric panel) of the gas bag, so that the envisaged position of the opening, through which the emblem region passes into the interior space of the gas bag during deployment of the same, does not require any additional outlay during production of the gas bag.

Moreover, this opening may also serve as an outflow opening which is in any case required and through which the gases which have been admitted can be discharged again into the surroundings during and after inflation of the gas bag.

If the opening through which the emblem region passes into the interior space of the gas bag during deployment of the same is not to serve at the same time as an outflow opening, a flexible tube can extend from this opening into the interior of the gas bag, which surrounds the emblem region and is closed at its end which faces away from the opening in such a manner that, when the gas bag is inflated, gas cannot penetrate into the flexible tube. For this purpose, the flexible tube can be secured at its end which faces away from the opening on a subassembly of the airbag module, for example on a gas generator or a diffuser of the gas generator.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 shows a section through an airbag module having a module housing, a gas bag, and a gas generator for inflating the gas bag;

FIG. 2 shows a plan view of the airbag module from FIG. 1 with a partially broken open illustration of the covering of the module housing;

FIG. 3 shows a plan view of the module housing from FIG. 1 with a complete covering of the module housing;

FIG. 4 shows the module housing from FIG. 1 during deployment of the gas bag;

FIG. 5 shows the module housing from FIG. 1 after deployment of the gas bag;

FIG. 6 shows a section through the airbag module from FIG. 1 in an alternative refinement.

### DESCRIPTION

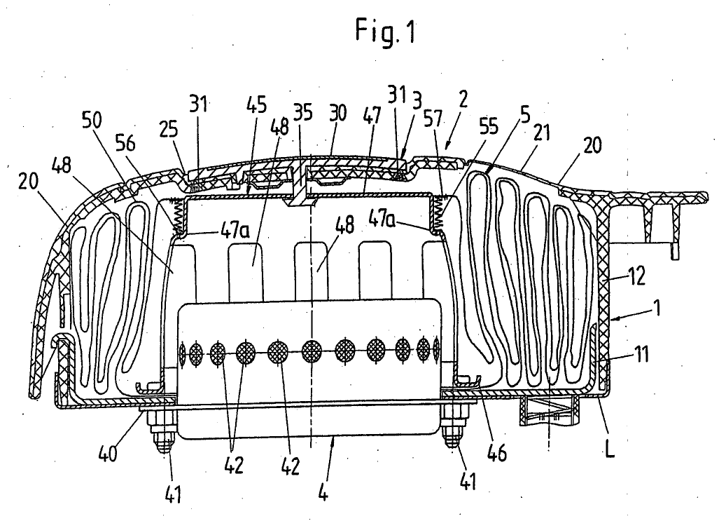

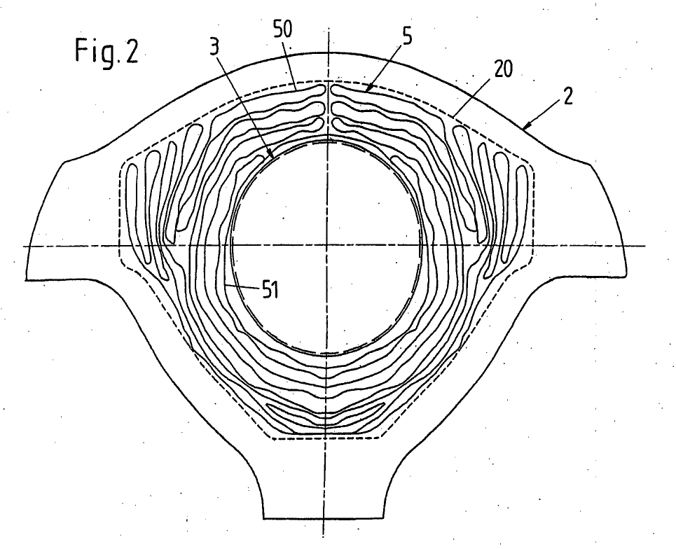

FIGS. 1 to 3 illustrate an airbag module which has a module housing 1 with a covering 2, a gas bag 5 which is arranged within the housing 1 and a gas generator 4 for inflating the gas bag 5. The airbag module is a driver's airbag module which is to be arranged on the steering wheel of a motor vehicle and which serves to protect the driver of the corresponding motor vehicle.

The housing 1 comprises an essentially cup-shaped lower housing part 11 and an upper housing part 12 which is latched thereto, the housing parts forming a cavity for holding the gas generator 4 and the gas bag 5. A covering 2 is provided on the upper housing part 12, which covering, when the gas bag 5 is inflated by the gas generator 4, opens up an opening for the deploying gas bag, so that the gas bag can deploy in the direction of a vehicle occupant to be protected.

For this purpose, the covering 2 has six flaps 21, 21a, 22, 23, 23a and 24, of which, when the associated steering wheel is in the straight ahead position, flaps 22 and 24 respectively point toward “12 o'clock” and “6 o'clock” and flaps 21, 21a point toward “10 o'clock” and “2 o clock”, and flaps 23, 23a point toward “4 o'clock” and “8 o'clock”.

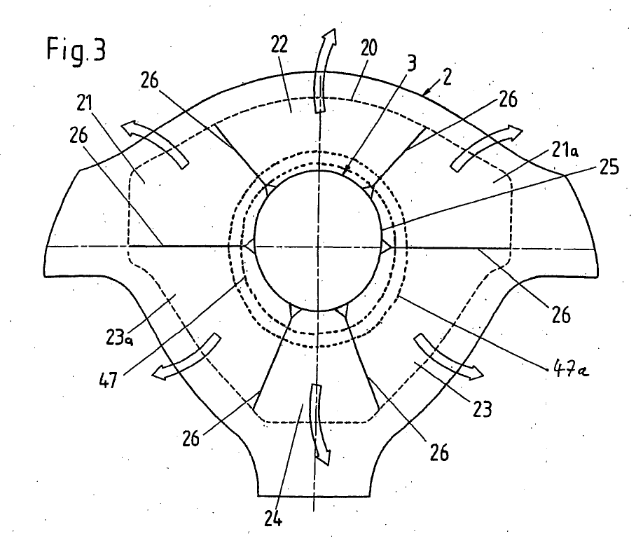

The six flaps 21 to 24 are connected in an articulated manner to the basic body of the covering 2 via a film hinge 20, which runs around the covering 2, with the result that, owing to the forces which occur during deployment of the gas bag 5, the flaps 21 to 24 can be pivoted in such a manner (for example, as shown in the corresponding arrows in FIG. 3) that they open up an opening, which annularly surrounds the central emblem region 3 of the covering 2, for the deploying gas bag. To this end, flaps which are arranged next to each other are connected to each other via a respective tear seam 26, and the flaps are also connected to the emblem region 3 of the covering 2 via a further tear seam 25 which surrounds the emblem region 3. The tear seams 25, 26 are designed in such a manner that they tear open under the action of the deploying gas bag 5, as the flaps 21 to 24 pivot, and do not obstruct the production of an opening for the gas bag 5.

The central emblem region 3 of the covering 2 serves to hold an emblem 30 which may, for example, indicate the manufacturer of the corresponding motor vehicle. The emblem region 3 is connected to the basic body of the covering 2 in a known manner via suitable fastening elements 35.

Furthermore, FIG. 1 schematically illustrates additional fixing means 31 with which the emblem region can be fixed in advance in a position relative to the basic body of the covering 2. This is significant, in particular if the emblem 30 and/or the emblem region 3 has to be fixed on the basic body of the covering for manufacturing reasons, for example in order to weld, crimp or rivet the emblem 30 and/or the emblem region 3 to the covering. The desired orientation of the emblem 30 is thus reliably reached. If fixing in advance is not necessary, then the emblem 30, covering two and/or a diffuser 45 may also be connected just by the fastening means 35.

In order to inflate the gas bag 5, a gas generator 4, which is fastened by its flange 40 via connecting means 41 such as but not limited to a screw with an associated nut to the bottom of the lower housing part 11, is arranged in the housing 1. To secure the latching connection between the upper and the lower housing part 11 against release, a securing plate L is arranged between the flange 40 and the bottom of the lower housing part 11.

Arranged above the gas generator 4, which is provided with discharge openings 42, is a diffuser 45, which is likewise provided with discharge openings 48 and serves for the targeted introduction into the gas bag 5 of gases being discharged from the gas generator 4, the direction in which the gases are admitted into the gas bag 5 being defined by the arrangement of the discharge openings 48 of the diffuser 45.

By means of its angled, lower end section 46, the diffuser 45 is connected to the flange 40 and the lower housing part 11 via the above-mentioned connecting means 41. At the same time, the gas bag 5 is clamped in the region of its blow-in mouth, through which the gas generator 4 is introduced into the gas bag 5, between the angled, lower section 46 of the diffuser 45 and the lower housing part 11 and is therefore fixed within the airbag module.

The upper top surface 47 of the diffuser 45 serves for fixing the emblem region 3 of the airbag module in the central region of the airbag module by the emblem region 3 engaging with a fastening means 35 in the top surface 47 of the diffuser 45, 50 that the emblem region 3 is connected in a fixed position to the diffuser 45 (usually consisting of metal). The effect achieved by this is that the emblem region 3 and the associated emblem 30 remain fixed in the central region of the airbag module during deployment of the gas bag 15 5. The opening which forms during pivoting of the flaps 21 to 24 of the covering 2 therefore surrounds the emblem region 3 in an annular manner.

In the figures shown, the emblem region 3 is arranged at a certain distance from the upper top surface 47 of the diffuser 45. In this case, an appropriate design of the fastening means 35 can make it possible for the emblem region 3 to move relative to the top surface 47. In this situation, the gap between the upper top surface 47 of the diffuser 45 and the emblem region 3 can be used, for example, for the purpose of arranging a mechanism for triggering a horn contact. Means for spanning a distance caused by the design or the manufacturing between the emblem region 3 and the top surface 47 can also be arranged in the gap, with the result that the emblem region 3 is supported relative to the top surface 47. However, the emblem region 3 may also rest directly on the upper top surface 47 of the diffuser 45.

The casing 50 of the gas bag 5 is folded in order to be able to stow the gas bag 5 in a compact form within the housing 1. Furthermore, the casing 50 of the gas bag 5 has an opening 51 which, in the folded state of the gas bag 5, surrounds the top surface 47 of the diffuser 45. During deployment of the gas bag 5, the emblem region 3 of the airbag module can penetrate through this opening 51 into the interior of the gas bag 5, with the result that the deployment of the gas bag 5 is not obstructed by the spatially fixed, central emblem region 3. Expressed in other words, the opening 51 is arranged in the gas bag casing 50 in such a manner and is dimensioned in such a manner that it is drawn over the emblem region 3 during deployment of the gas bag 5.

In order to prevent the gas which flows from the gas generator 4 into the gas bag 5 in the event of a crash from being able to flow through the opening 51 in the gas bag casing 50 into the surroundings, a flexible tube 55 made of fabric is provided, one end 57 of which is fastened to the edge of the opening 51 (for example by means of a seam) and which completely surrounds the opening 51, and the other end 56 of which is fastened to a shoulder 47a in the region of the top surface 47 of the diffuser 45.

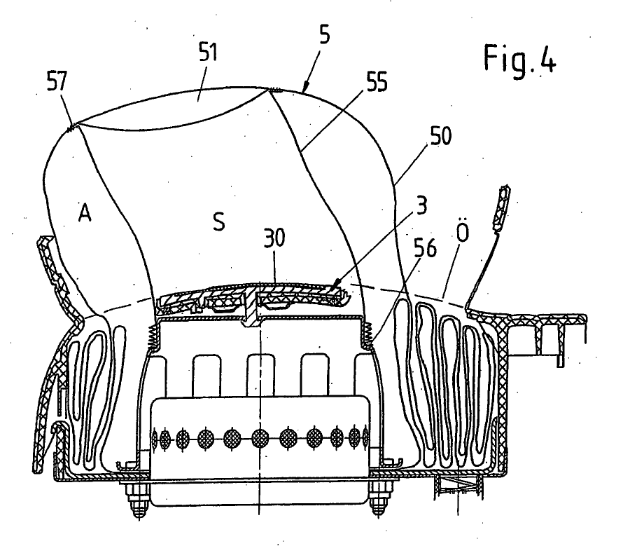

In the folded state of the gas bag 5, the flexible tube 55 is placed around the diffuser 45, in the region of the top surface 47 thereof, and, in the same manner as the opening 51 in the gas bag casing 50, is drawn over the emblem region 3 during deployment of the gas bag 5, as is made clear with reference to FIG. 4.

FIG. 4 shows the airbag module from FIGS. 1 and 3 in a sectional illustration according to FIG. 1 during deployment of the gas bag 5, which is inflated by gases emerging from the gas generator 4. In FIG. 4, it can be seen, in particular, that the flaps 21 to 24 of the covering 2 of the module housing 1 pivot in such a manner during deployment of the gas bag 5 that they open up an opening O which annularly surrounds the emblem region 3 and through which the gas bag 5 can deploy. In this connection, first of all the opening 51 in the gas bag casing 50 and then the flexible tube 55 are drawn over the central emblem region 30, with the result that the emblem is arranged within the flexible tube 55.

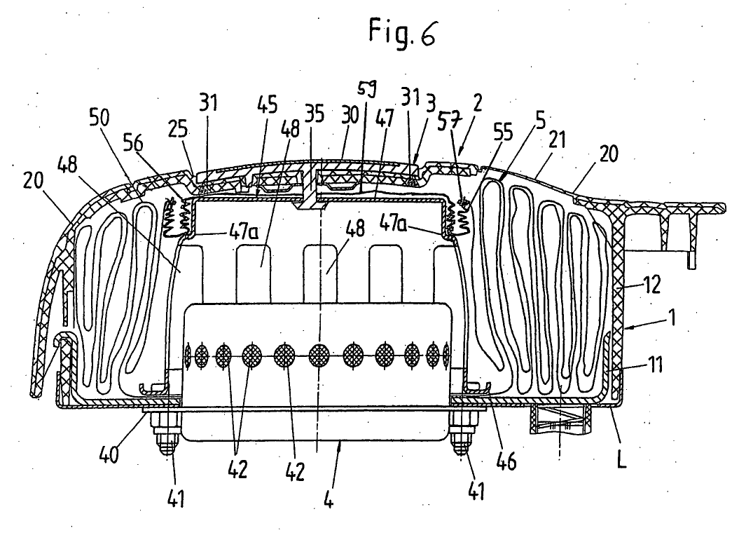

The flexible tube 55 divides the interior of the gas bag 5 into two regions which are separated from each other in a gastight manner. The gas bag region S which is positioned within the flexible tube 55 communicates via the opening 51 in the casing 50 of the gas bag 5 with the surroundings, i.e. with the environment of the gas bag 5. The gases being discharged from the gas generator 4 cannot pass into this gas bag region S which is positioned within the flexible tube 55, since the flexible tube 55 is closed at its end 56, which faces away from the opening 51 and is arranged within the gas bag casing 50, by the fact that it is fastened to a shoulder 47a of the diffuser 45. As an alternative, as FIG. 6 shows, the flexible tube 55 can also be closed at its end 56 positioned within the gas bag casing 50 by means of a fabric tab 59 or another top surface. In this case, the fabric tab 59 or the other top surface runs over the end 56 of the flexible tube 55 below the emblem region 3 between the emblem region 3 and the top surface 47 of the diffuser 45.

The sole crucial factor is for the flexible tube 55 to be arranged and designed in each case at both of its ends 56, 57 in such a manner that gas cannot flow into the gas bag region S which is surrounded by the flexible tube 55. This prevents the gas which enters into the gas bag 5 during the inflation process from being able to flow out again through the opening 51 in the casing 50 of the gas bag 5. On the contrary, these gases remain in the working region A of the gas bag 5, which does not communicate with the surroundings via the opening 51.

On the other hand, it is necessary, however, for the gases which flow into the gas bag 5 during inflation of the gas bag to be discharged continuously into the surroundings (the environment of the gas bag 5). For this purpose, suitable outflow openings have to be provided in the casing 50 of the gas bag.

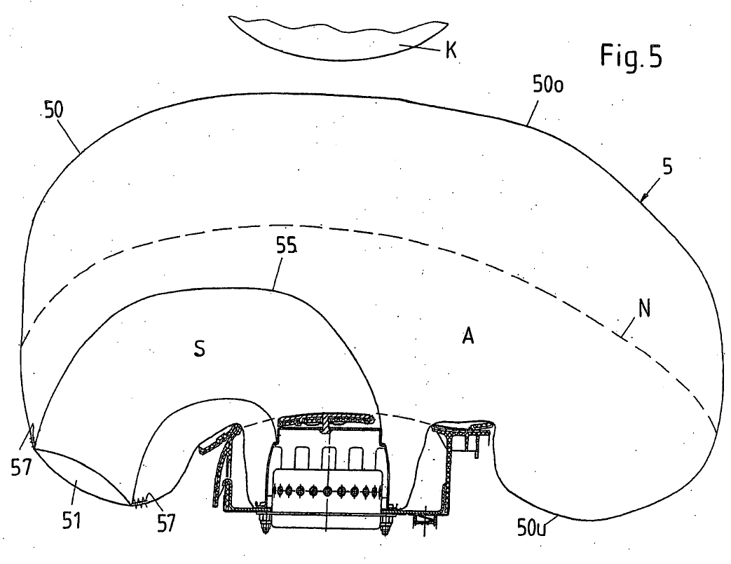

FIG. 5 shows the airbag module in an illustration according to FIGS. 1 and 4 after the gas bag 5 is inflated. It can be seen with reference to FIG. 5 that the casing 50 of the gas bag 5 comprises a lower part 50u (lower panel) and an upper part 50o (upper panel), which parts are connected to each other along a connecting line N, in particular are sewn to each other in order to form a connecting seam. In the inflated state of the gas bag 5, as is illustrated in FIG. 5, the upper part 50o of the gas bag casing 50 faces the upper body (including the head) of the occupant to be protected and the lower part 50u faces away from the upper body of the vehicle occupant to be protected.

According to FIG. 5, the opening 51 in the gas bag 25 casing 50 is situated in the lower part 50u of the gas bag casing 50 and therefore faces away from the upper body of the vehicle occupant to be protected. There is thereby no risk of the vehicle occupant to be protected colliding with the emblem region 3 of the airbag module. On the contrary, the emblem region is completely covered by the upper part 50o of the gas bag 5.

The opening 51 in the gas bag casing 50 does not 35 absolutely have to be arranged on that side of the gas bag casing 50 which completely faces away from the upper body of the occupant to be protected. Such a lateral arrangement of the opening 51 in a region of the gas bag casing 50 is also conceivable such that the opening points laterally outward in a direction past the upper body of the occupant to be protected.

For this purpose, the opening 51 can be provided, for example, in the region of the connecting seam N of the two parts 50o, 50u of the gas bag casing 50. In particular, the opening 51 can be formed by an interruption of the connecting seam N.

The only important factor is that the opening 51 does not lead into that region of the gas bag casing 50 which, after inflation of the gas bag, faces the upper body (including the head) of the occupant to be protected. The position of the upper body K of the occupant to be protected illustrated schematically in FIG. 5.

The priority application, Germany Patent Application No. 102 03 960.7, filed Jan. 25, 2002 including the specification, drawings, claims and abstract, is incorporated herein by reference in its entirety.

While preferred embodiments have been illustrated and described, it should be understood that changes and modifications can be made therein in accordance with ordinary skill in the art without departing from the invention in its broader aspects as defined in the specification.

What is claimed is:

1. An airbag module for a motor vehicle comprising:
an airbag configured to inflate and deploy from the module to protect a vehicle occupant, wherein the airbag is positioned under a cover prior to inflation;
wherein the cover is configured to open for the deploying airbag; and
wherein the cover includes a fixed emblem region and wherein the airbag includes an opening through which the emblem region passes into the interior of the airbag during deployment of the airbag, and wherein the opening is positioned so that when the airbag is inflated the opening does not point in the direction of the upper body of the occupant to be protected.

2. The airbag module is claimed in claim 1, wherein the opening points laterally outward in a direction past the upper body of the occupant.

3. The airbag module of claim 1, wherein the opening points in a direction away from the upper body of the occupant.

4. The airbag module of claim 1 further comprising an upper part and a lower part of the airbag, and wherein the upper part faces the upper body of the occupant to be protected in the inflated state of the airbag.

5. The airbag module of claim 4, wherein the opening is provided in the lower part of the airbag.

6. The airbag module of claim 1 wherein the airbag includes two separate parts which are connected to each other.

7. The airbag module of claim 6, wherein the opening is provided in the region of a connecting seam of the two airbag parts.

8. The airbag module of claim 1 further comprising a flexible tube extending from the opening into the interior of the airbag.

9. The airbag module of claim 8, wherein the flexible tube is closed at its end which faces away from the opening with the result that, when the airbag is inflated, gas cannot penetrate into the flexible tube.

10. The airbag module of claim 8, wherein the flexible tube is secured at its end which faces away from the opening on a subassembly of the airbag module, in particular on a gas generator or on a diffuser of the gas generator.

11. The airbag module of claim 10, wherein the flexible tube is secured on the subassembly in such a manner that gas cannot penetrate into the flexible tube through that end of the same which faces away from the opening of the airbag.

12. The airbag module of claim 1, wherein the emblem region is supported relative to a subassembly of the airbag module, in particular relative to a gas generator or a diffuser of the gas generator.

13. The airbag module of claim 12 further comprising a means for supporting the emblem region.

14. The airbag module of claim 1, wherein the emblem region can be moved relative to a subassembly of the airbag module, in particular relative to a gas generator or a diffuser of the gas generator.

15. The airbag module of claim 14, wherein the movable emblem region is connected to transmission means for triggering an electrical contact, in particular a horn contact.

16. A airbag for use in an airbag module having a cover with a emblem region, comprising;
an inflated state and a folded state wherein the airbag is adapted to be inflated to protect a vehicle occupant;
a casing which, in the inflated state of the airbag, has a section facing an upper body of the vehicle occupant to be protected; and
a section defining an opening through which the emblem region passes into the interior of the airbag during deployment;
wherein in the inflated state of the airbag, the opening does not point in the direction of the upper body of the occupant to be protected.

17. The airbag of claim 16, wherein the airbag comprises an upper part and a lower part, and further wherein the upper part facing the upper body of the occupant to be protected in the inflated state of the airbag.

18. The airbag of claim 16 further comprising a flexible tube extending from the opening into an interior of the airbag which surrounds the emblem region.

19. The airbag module of claim 16, wherein the emblem region is supported relative to a subassembly of the airbag module, in particular relative to a gas generator or a diffuser of the gas generator.

20. An airbag module for a motor vehicle, comprising:
a airbag which can be inflated to protect a vehicle occupant and the casing of which, in the inflated state of the airbag, has a section facing the upper body of the vehicle occupant to be protected;
a covering of the airbag module, behind which the airbag is arranged in the folded state and which, when the airbag is inflated, opens up an opening for the deploying airbag; and
a region of the covering, which is arranged in a fixed position, wherein the airbag has, in its casing, an opening through which the region passes into the interior of the airbag during deployment, and in that, in the inflated state of the airbag, the opening does not point in the direction of the upper body of the occupant to be protected.
